(19) United States
(12) Patent Application Publication
(10) Pub. No.: US 2010/0057246 A1
(43) Pub. Date: Mar. 4, 2010

(54) CONVEYING APPARATUS FOR DEPALLETIZING GOODS STACKED ON A GOODS SUPPORT

(75) Inventors: Rudolf Hansl, Linz (AT); Jörg Bergmann, Wels (AT); Thomas Radler, Wels (AT)

Correspondence Address: LERNER, DAVID, LITTENBERG,;KRUMHOLZ & MENTLIK, 600 SOUTH AVENUE WEST, WESTFIELD, NJ, 07090, US

(73) Assignee: TGW Transportgeräte, Wels (AU)

(21) Appl. No.: 12/309,961

(22) PCT Filed: Aug. 2, 2007
(86) PCT No.: PCT/AT2007/000374

§ 371 Date: Sep. 28, 2009

(30) Foreign Application Priority Data
Aug. 3, 2006 (AT) A 1309/2006

(51) Int. Cl. B65G 59/04; G06F 7/00

(52) U.S. Cl. 700/215; 414/796.2; 700/218

(57) ABSTRACT

The invention describes a conveying apparatus (1) for depalletising and removing, or advancing, goods (4), or goods containers (5) which are stacked in a number of layers (3) on a goods support (2), in particular a pallet, with a lifting action conveying arrangement (7) with load carrying means (13) for the goods support (2) and with a conveying apparatus, e.g. a belt conveyor, roller conveyor etc., extending in a conveying plane (21) perpendicular to a lifting direction, adjustable in the direction of removal of the goods (4) relative to the load carrying means (13) and having an inclined run-on plane (35) facing the conveying plane (21), and with a removal and/or lifting device (45) for separating layers (6), e.g. cardboard separating sheets, arranged between the layers (3) or goods (4) or goods containers (5).

The conveying apparatus is formed by an accommodating conveying arrangement (18) forming the run-on level (35), adjustable reversibly in the removal direction via an adjusting drive (23) in a guide path (22), and at least one transfer conveying arrangement (19) arranged downstream in the removal direction and independently adjustable relative to the accommodating conveying arrangement (18) via an adjusting drive (24) in the guide path.

The invention relates to a conveying apparatus as described in claim 1, as well as a method of operating the conveying apparatus as described in claim 38.

From JP 2003-081426 A a conveying apparatus is known for depalletising layer by layer goods stacked on a goods support whereby a goods support with goods is supported on a lifting action conveying arrangement formed by a scissor lifting platform and the stacked goods corresponding to the layer to be depalletised are positioned in a vertical direction on a conveying apparatus forming a conveying plane arranged downstream of the layer in the direction of removal. Independently of the lifting action conveying arrangement the known apparatus also has a vertically adjustable manipulation device for securing the position and recording the layer to be depalletised and its transfer to a roller conveyor arranged downstream in the direction of removal.

Document EP 1 187 782 B1 discloses an apparatus for handling layers of goods arranged on pallets with a vacuum lifting head, operated by means of a lifting and transferring apparatus, which is placed on the goods to be depalletised, and with a number of suction chambers, which can be subjected to a vacuum via a number of individually controllable valves, to lift the goods from one layer and transfer them to a conveying arrangement.

From WO 02/10043 A an apparatus for depalletising layers of articles stacked on goods supports is also known in which by way of a lifting arrangement with a suction device the layer to be depalletised is lifted from the goods support and transferred to a conveyer arranged downstream in the direction of removal and by means of a further, lifting device independent thereof, separating layers, e.g. cardboard separating sheets arranged between the layers are lifted off after removal of the layer of articles and stacked in a storage arrangement next to the place at which the goods support is set up.

From a further document, DE 26 31 942 A1, a depalletising apparatus is known with a conveyor arrangement forming a wedge-shaped run-on plane in an end area. In this conveyor arrangement a roller which rotates about a horizontal axle and is borne in a spring-loaded manner in a slide can be placed against side wall of a pack. As result of friction resistance the edge of the pack is lifted after which the roller or a belt-like conveyor guided via the roller is introduced into the intermediate space under the pack, whereby the pack is taken up by the conveyor arrangement in the direction of removal.

The aim of the invention is to create a conveying apparatus for depalletising and removing or advancing goods or containers stacked in several layers on a goods support, more particularly a pallet, with which the manipulation idle times are minimised in order to speed up the depalletising process.

This objective of the invention is achieved through the features set out in the characterising section of claim 1. The surprising advantage is that due to an uncoupled removal process, through the independently operated conveying arrangement for taking up a series of layers or layer of the goods or goods containers stacked on the goods support and their advancing and also manipulation taking place practically simultaneously with the taking up process to remove the freed separating layer, idle times interrupting the flow of goods can be avoided whereby the turnover of goods is increased.

Advantageous in this are the embodiments described in claims 2 to 9 as in this way for the different manipulation requirements, through components designed for multiple use the technical costs can be reduced and a high level of cost-effectiveness of the conveying apparatus can be achieved.

However, a further development as described in claim 10 is also advantageous as through a spring-loaded movement sequence during the feed movement and procedure of introducing the accommodating conveying arrangement between the layers of goods or goods containers sensitive, protective and secure accommodation of the goods takes place and damage, incorrect handling and increased wear are effectively avoided.

Also possible is an advantageous further development as described in claim 11, whereby via electronic recording means, e.g. force measuring sensors, proximity sensors etc, operating conditions can be recorded and the procedure introducing the accommodating conveying arrangement between the layers of goods or goods containers is, through controlling an adjusting drive, e.g. a tension drive operated by means of a regulated servo motor, for example, according to specifications depending on the properties of the goods or goods containers, can be adapted to requirements or controlled in accordance with predetermined parameters.

Also of advantage is an embodiment in accordance with claim 12 with which securing of the goods or goods containers stacked on the goods support is achieved during the accommodating manipulation, as a result of which through more rapid movement sequences cycle times are shortened and faults due to an incorrect manipulation are avoided.

Here, embodiments such as those described in claims 13 to 17 are advantageous as a simple and fail-safe technical design with low susceptibility to wear is achieved with them, which results in a reduction in maintenance costs.

Also possible though are advantageous further developments in accordance with claims 18 and 19 whereby on taking up a layer or layer row of goods or goods containers tilting is made possible so as to form a wedged shaped free space into which the accommodating conveying arrangement for taking up the layer series or layer can be introduced.

Retention means as described in claim 20 are also advantageous as in this way the layers or rows of layers remaining under the conveying level are effectively secured against being carried along by friction by the accommodating conveying arrangement moving in the direction of removal.

Through the advantageous embodiment described in claim 21, technically tried and tested, low-maintenance and cost-effective drives are achieved.

Through the advantageous embodiments as described in claims 22 to 32, wear-causing accommodation resistance on introduction of the accommodating conveying arrangement or the conveying modules can largely be reduced, and components exposed to wear due to relative movement of the conveying means and the goods or goods containers to be accommodated, such conveyor bands, conveyor belts, can be technically and more cost effectively replaced, and a run-on level can be optimised through position determination of the conveying modules or an upstream conveyor roller.

Also possible are advantageous further embodiments as described in claims 33 and 35 whereby the use of the conveying apparatus in a storage area, more particularly a high-shelf store is achieved, thereby bringing about a high degree of cost-efficiency of a goods turnover store as both depalletising and palletising or repalletising or restocking processes are possible within the high-shelf store.

Finally, embodiments in accordance with claims 36 and 37 are advantageous as secure accommodation of the goods or goods containers at a position on a store shelf is achieved through the accommodating arrangements, whereby these embodiments with the telescopic extension and adjustable end flaps do not require additional free space in the storage shelf as a result of which a high degree of utilisation of storage space is achieved.

The aim of the invention is also to provide a method of operating a conveying apparatus for depalletising and removing and advancing goods or containers stacked in several layers on a goods support, more particularly a pallet, in which processes overlap in time during goods turnover in order to minimise turnover times.

This aim of the invention is achieved in accordance with the measures set out in claim 38. The surprising advantage is that in this way a high degree of automation is achieved with a high degree of process security through an interlinking of the measures and monitoring of the processes in the operation of the conveying apparatus, as a result of which operational costs are reduced and a high degree of operational security and cost-effectiveness are achieved.

Finally, the measures in accordance with claims 39 to 41 are advantageous whereby without adapting or converting control programs and/or the technical equipment the most essential processes taking place in a good turnover store can be controlled and monitored.

For a better understanding of the invention it is explained below in more detail below with the aid of the examples of embodiment shown in the figures, where

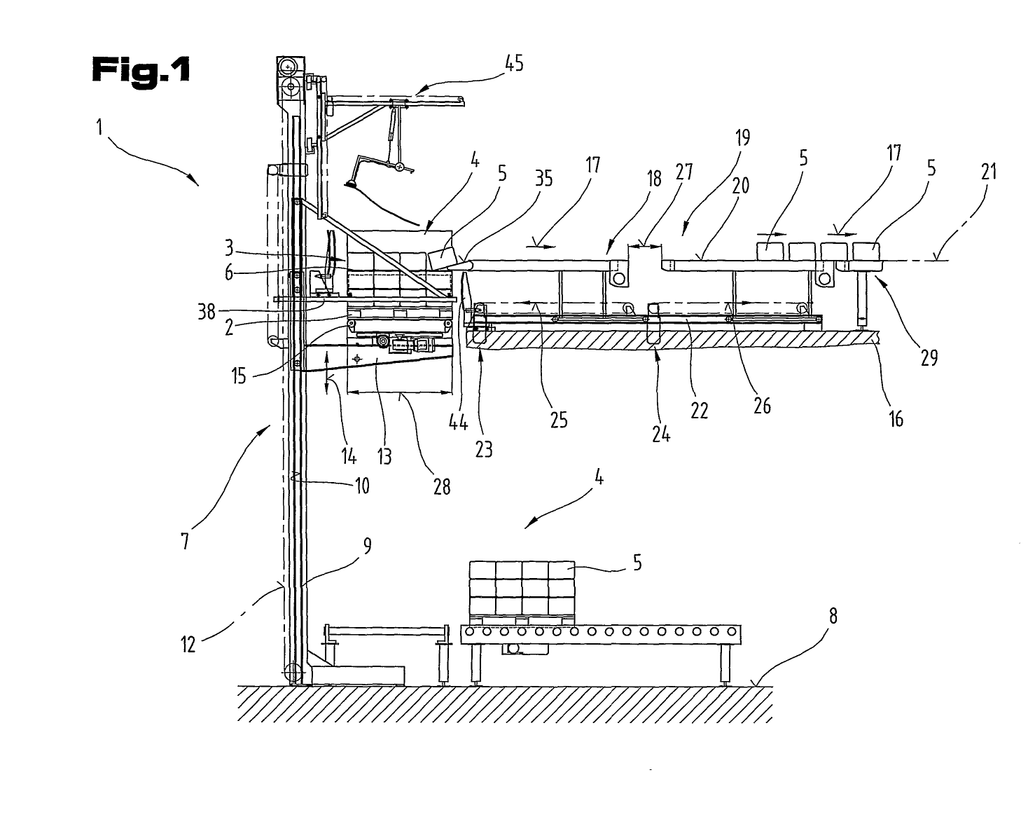

FIG. 1 shows a view of a conveying apparatus in accordance with the invention;

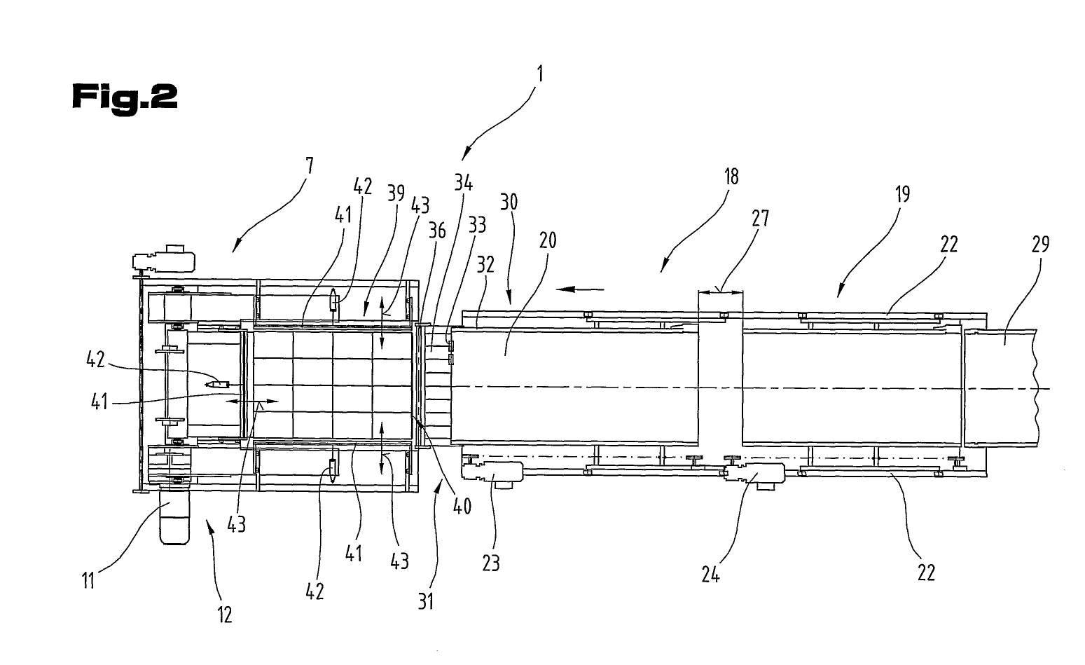

FIG. 2 shows a view of the conveying apparatus from above;

FIG. 3 shows a view of a fastening arrangement of the conveying apparatus;

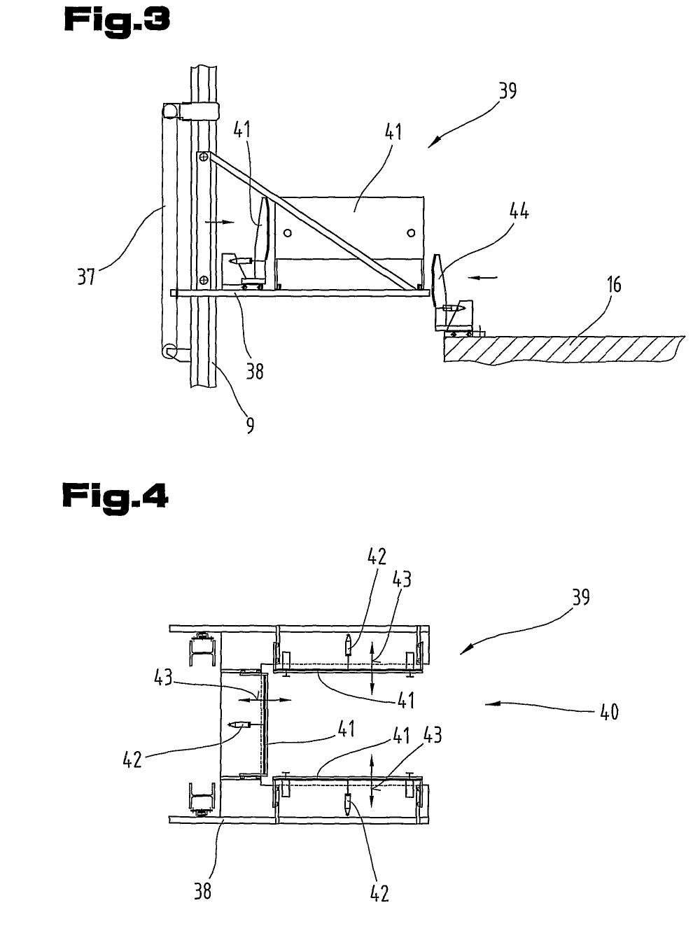

FIG. 4 show a view of the fastening arrangement from above;

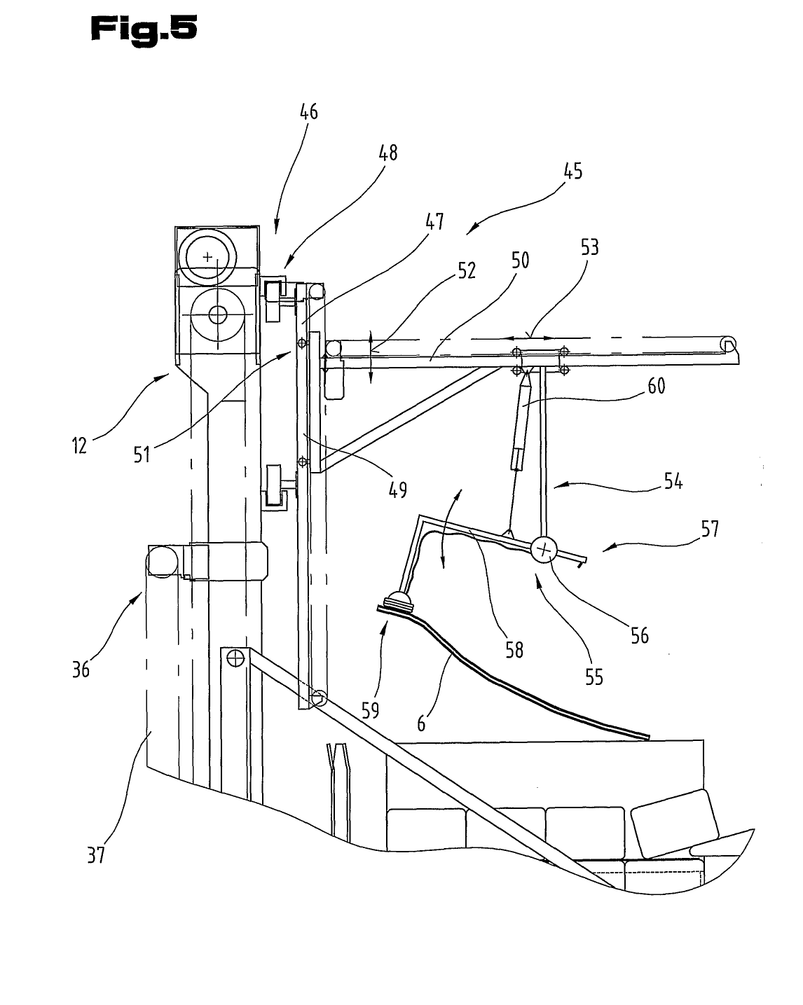

FIG. 5 shows a detailed view of the removing/lifting device of the conveying apparatus;

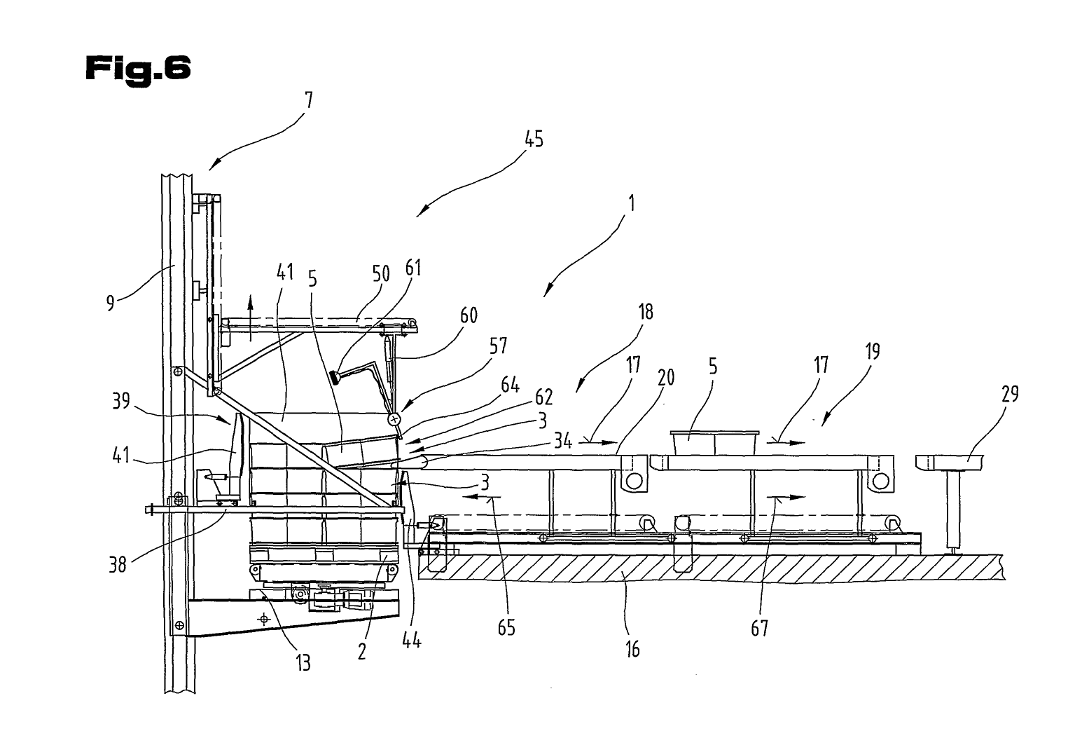

FIG. 6 shows the removing/lifting device with a lifting gripping device;

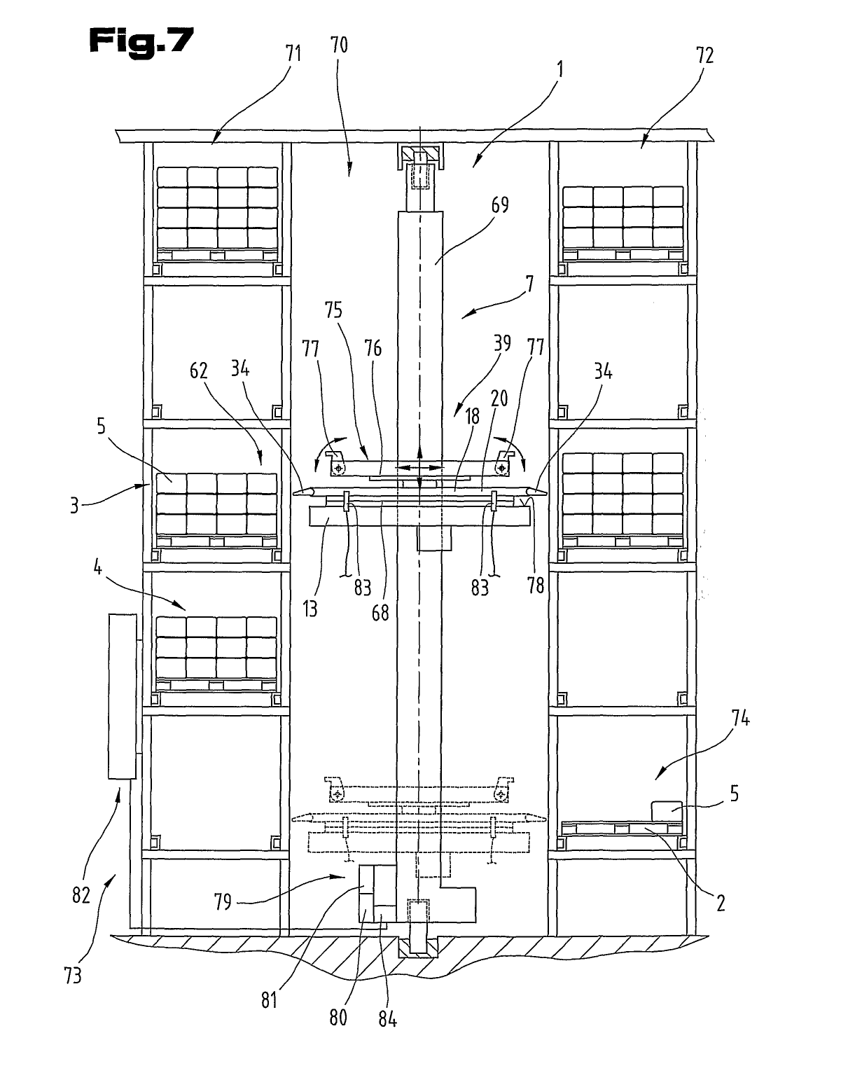

FIG. 7 shows a view of the conveying apparatus with a shelf operating device;

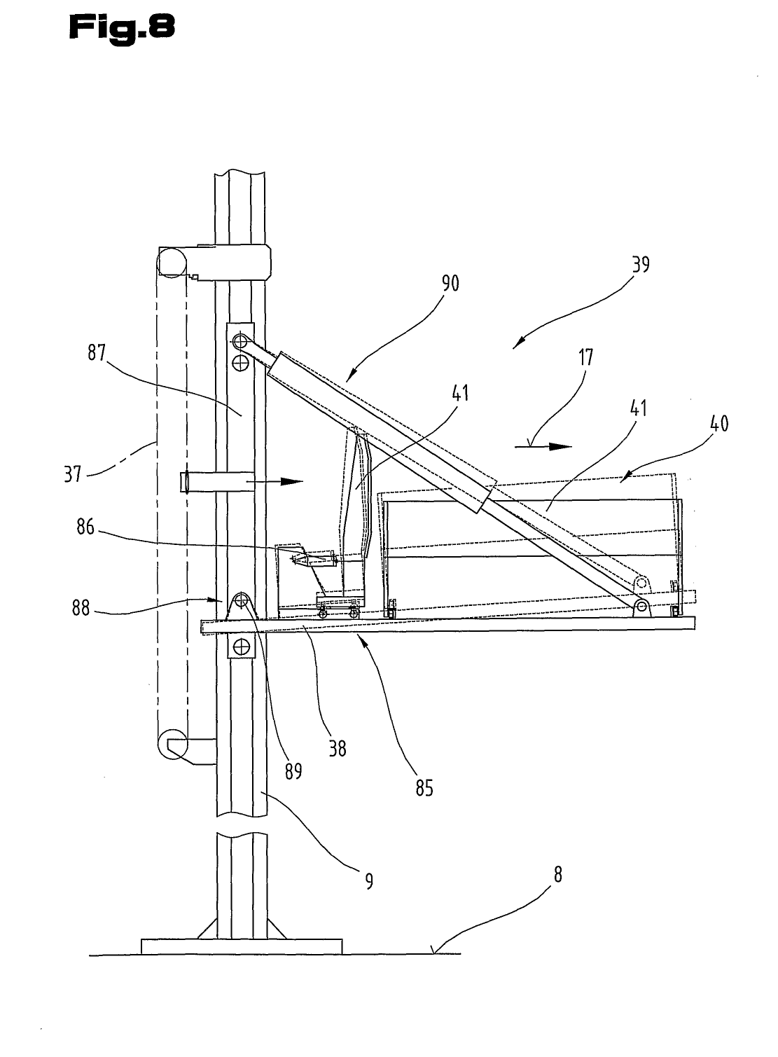

FIG. 8 shows a view of another embodiment of the fastening arrangement;

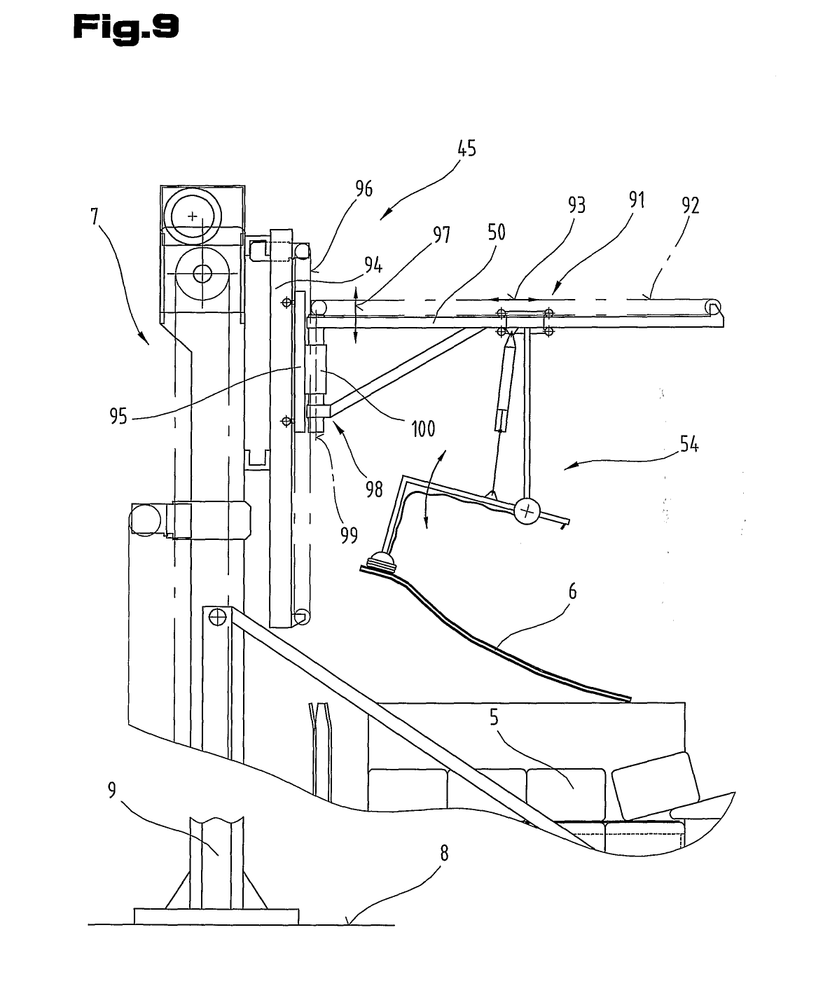

FIG. 9 shows a view of a further embodiment of the accommodating and lifting arrangement.

To begin with it is pointed out that in the various described forms of embodiment the same components are given the same reference numbers and/or the same component designations, whereby the disclosures contained in the entire description can be transferred accordingly to the same parts with the same reference number or the same component designations. The position details selected in the description, e.g. top, bottom, laterally etc. also relate to the directly described and shown figure and can in the event of position change can be transferred accordingly to the new position. In addition, individual features or combinations of features from the shown and described examples of embodiment can constitute solutions in themselves that are separate, inventive or in accordance with the invention.

In FIGS. 1 and 2 a conveying apparatus for the depalletising and removal or advancing of goods 4 or goods containers 5, e.g. packs, bottles, containers etc., stacked in several layers 3 on a goods support 2, e.g. a pallet, is shown. Depending on the properties of the goods 4 and/or goods containers 5 the layers are stacked directly on top of each other or with the use of a separating layer 6, e.g. cardboard separating sheets, between the layers 3.

The conveying apparatus 1 essentially comprises a lifting action conveying arrangement 7 with, supported on a support surface 8 and extending perpendicularly thereto, a post arrangement, preferably with two parallel masts 9 forming guide arrangements 10 in which is arranged a load carrying means 13 that can be adjusted—in accordance with the double arrow 14—by means of a lifting drive 11, e.g. by means of an electrically operated tension drive 11.

The shown example of embodiment shows a 2-level arrangement in which at a lower level the goods supports 2 bearing the stacked goods 4 of goods container 5 are brought in by means of a pallet conveyer, e.g. a roller conveyor, and transferred onto the load carrying means 13 by way of a roller or tension means conveyor 15 arranged on the load carrying means 13.

At level above this, separated for example by means of a ceiling 16, depalletising takes place after positioning of the good support 2 with a lifting action conveying arrangement 7 for conveying in a removal direction—in accordance with arrow 17—of the layer 3 or only individual good containers 5, for example one or more rows of stacks goods 4 in a vertical direction in relation to conveying arrangement 18.

Taking over of the goods 4 or containers 5 by the conveying arrangement 18 takes place in a known manner, by running under the layer 3 to be depalletised with the conveyor arrangement 18 in a separation plane—as will be described in detail at a later stage.

In the shown example of embodiment the layer 3 or row of containers is taken up by the accommodating conveying arrangement 18 and removed in a transfer conveying arrangement 19, downstream in the direction of removal—in accordance with arrow 17, which with conveying means 20, preferably conveyer belts, form a joint conveying plane 21 parallel to the support surface 8.

The accommodating conveying arrangement 18 and the transfer conveying arrangement 19 can each be adjusted independently of each other in a guide path 22 parallel to the conveying plane 21 via an adjusting drive 23, 24 in the direction of conveying—according to arrow 17, reversibly—according to arrows 25, 26, whereby the adjustability is designed so that the accommodating conveying arrangement 18 and the transfer conveying arrangement 19 can be adjusted cheek to cheek with the conveying means 20 or at maximum distance 28 which corresponds approximately to a length 28 of the load carrying means 13.

At an end position of the transfer conveying arrangement 19 at a distance from the lifting action conveying arrangement 7, in the removal direction—according to arrow 17—direct removal and advancing of the depalletised goods 4 on a downstream conveying arrangement 29 is envisaged whereby a separation device, distribution device etc can be arranged before it if required.

For the secure conveying of differently designed good containers 5, the accommodating conveying arrangement 18 is preferably formed by a conveyor belt 30, which in an end section 31 facing the lifting-action conveying arrangement 7 has at least one conveying module 34, preferably attached to a bearing frame 32, preferably by coupling means 33, which is wedge-shaped in the direction of the lifting action conveying arrangement 7 and thereby forms a inclined run-on plane 35 relative to the conveying plane 21.

Through this wedge-shaped form of the conveying module 34, after slight tilting of the goods container 5, either through the frictional effect of the conveyor module 34 or the moving conveying means, e.g. conveyer belt, conveyor strap or a side of the goods container 5, or after a lifting process—to be described in detail at a later stage—a free space is created between the layers 5 into which the accommodating conveying arrangement 18 can be inserted through adjustment in the direction of the load carrying means 13, whereby the layer to be depalletised 5 is taken up by the conveying means 20 and conveyed in the removal direction—in accordance with arrow 17—in the direction of the subsequent transfer conveying arrangement 19.

Preferably the accommodating conveying arrangement 18 has, facing the load carrying means 13, several adjacent conveying modules 34 over the conveyor width which are either driven by means of the accommodating conveying arrangement 18 or via a separate drive.

Preferably the conveying modules 34, arranged next to each other in rows, are drive-coupled to each other, but, preferably for maintenance measures, e.g. changing the belt, strap, easily interchangeable, for which reason the coupling means 33 are designed so as to permit this.

A further advantageous embodiment consists in providing the conveying modules 34 with an upstream driven conveying roller 36 with a relatively small diameter and with a surface quality that exhibits a high coefficient of friction. Preferably the conveying roller 36 is jointly driven via the drive of the accommodating conveying arrangement 18 or of the conveying modules 34.

As can also be seen from FIGS. 1 and 2, on the post 9, via a further lifting drive 37, e.g. the tension means drive 12, a carrier frame 38 is arranged in the lifting direction, which is adjustable relative to the load carrying means 13, and on which an abutment arrangement 39 formed by abutment means 41 surrounding an accommodating space 40 on three sides is provided. One abutment means limits the accommodating space 40 in the direction of the post 9 and the others laterally limit the accommodating space 40 opposite to each other.

As can now also been seen from FIG. 3, the abutment means 41 are adjustable arranged—in accordance with the double arrow 43—via adjusting means 42, e.g. a cylinder operated by a pressure medium, between an inner position, at which the abutment means 41 closely surround the goods 4 arranged on the goods support 2, and an outer position on the carrier frame 38.

Due to the adjustability of the carrier frame 38 with the abutment arrangement 39, which is independent of the load carrying means 13, it is possible to move the abutment means 41 relative to the load carrying means 13 into a position in which the layer 3 to be depalletised, i.e. the layer 3 above the conveying plane 21, is securely positioned. Of course it is also possible to select an abutment means 41 position below the conveying plane 21 if required. Preferably, facing the load carrying means 13, adjustable shield-like retention means 44, extending over a conveying width, are immovably arranged below the accommodating conveying arrangement 18, for example on the level ceiling 15, in order to additionally achieve securing of the goods 4 or goods containers 5 that are to remain on the goods support 2.

Through the described abutment arrangement 39 guiding of the goods 4 to be depalletised is achieved in the case of slackness of the abutment means 41. But it is also possible through the abutment means to achieve tensioning of the layer 3, or an individual row of the layer 3, more particularly through individually adjustable tensioning means on the abutment means 41. An embodiment of this type makes it possible, for example with a vertical position of the carrier frame 38 to lift by means of the lifting drive 36 the layer 3 on the accommodating conveying arrangement 18 in order to create a free space for the accommodating conveying arrangement 18 or the conveying modules 34 in order to assure that the layer 18 is transferred to the accommodating conveying arrangement 18.

Depending on the design and properties of the goods 4 and/or goods containers 5, lifting, as described above, can be of advantage for the depalletising procedure.

Depending on the design and properties of the goods 4 and/or goods containers 5, lifting of a layer 3 also takes place by way of the introduction of the accommodating conveying arrangement 18 provided with the wedge-shaped conveying module 34 and/or the conveying roller 36 during an adjusting movement of the accommodating conveying arrangement 18—in accordance with arrow 25—as due to friction when applying the conveying module 34 and/or the conveying roller 36 to the goods 4 to be depalletised, tipping takes place through the conveying means 20, resulting in an intermediate space for the introduction of the accommodating conveying arrangement 18 whereby the goods 4 are taken over by the conveying means 20 and conveyed in the direction of removal—in accordance with arrow 17.

As a result of the independent and reversible adjustability of the accommodating conveying arrangement 18 and the transfer conveying arrangement 19, as already set out with regard to FIGS. 1 and 2, it is possible to carry out depalletising with the transfer conveying arrangement 19 independently of advancing the goods 4 and/or goods containers 5 from the transfer conveying arrangement 19 to the conveying arrangement 29, whereby an essential acceleration of the depalletising process is achieved through saving the waiting times that would arise in the case of direct conveying of the goods 4 from the accommodating conveying arrangement to the conveying arrangement 29.

From FIGS. 1, 2 and in the detail of FIG. 5 a removal and/or raising arrangement 45 arranged on a post 9 of the lifting action conveying arrangement 7 in an area above the conveying level 21 can be seen, which is envisaged alternatively for the lifting and removal of the separating layer 6 and/or for raising the goods 4 and/or goods containers 5.

This is formed by a linear guide arrangement 46 transverse to the removal direction—in accordance with arrow 17—and parallel to the conveying plane 21, and a travelling slide 47 arranged to be linearly adjustable within it by means of a drive 48, e.g. the tensioning means drive. In one end position the travelling slide 27 is arranged approximately centrally with regard to the load carrying means 13 and in a further end position positioned next to the load carrying means 13.

On the travelling slide 47 there is a further linear guide arrangement 49 which is perpendicular to the conveying plane 21 and in which a jib 50 is adjustably guided—in accordance with double arrow 52—by means of a lifting drive 51, e.g. the tensioning drive.

One possible embodiment also consists in arranging the jib 50 on the travelling slide 47 about a pivoting axle running perpendicularly to the conveying plane 21 as will be described later in more detail, whereby the guiding arrangement 46 for the travelling slide 47 projecting laterally over the load carrying means 13 is avoided and a technically simple adjusting arrangement for the jib 50 is achieved.

Linearly adjustable—in accordance with the double arrow 53—on the jib 50 is a gripping arrangement 54 with a gripper head 57, borne in pivoting manner in a pivoting bearing 55 which forms a pivoting axle 56 running parallel to the conveying plane 21 and perpendicularly to the removal direction—in accordance with arrow 17, which is, for example formed of a multiple arm lever 58 and can be fitted need-specific gripping means 59, e.g. vacuum suction pads or lifting hooks, tong grips etc.

The positioning of the gripper head 57 for the envisaged function takes place by pivoting the lever 58 between two end positions, which takes place, for example, by adjusting means 60 operated with a pressurised medium.

With the aid of FIG. 5 the action mechanism is shown of the removal and/or raising device 45 for removing the separating layer 6 that becomes free during the depalletising procedure, which in an active position of the gripper head 57 and/or the lever 58 is taken up by a vacuum suction device 61 and through lifting of the gripper head 57 and moving in the removal direction—according to arrow 17—with ongoing lifting of the goods containers 5 onto the accommodating conveying arrangement 18 the separating layer 3 is loosened from the remaining layer 3 and taken up.

With this process almost simultaneous lifting of the goods 4 by the accommodating conveying arrangement 18 and removal of the separating layer to a laterally provided depositing device, e.g. a pallet, wire-mesh crate, compactor etc. is possible.

Due to the simultaneous lifting and transfer movement of the gripper head 57 the separating layer 6 is also reliably loosened if, as sometimes occurs, it sticks to the lower layer 3, due to adhesive residues etc.

FIG. 6 shows a simplified drawing of the removal and/or lifting device 45 and by way of the figure the further functions are described, for example, lifting a row of containers 62, followed by handling of goods containers 5 which are bulged on the upper edge 63. On the gripper head 57 there is at least one lifting hook 64 that engages under the bulged edge and brings about lifting of the goods container 5.

A container design of this type often consists of stackable goods containers with an open filling opening.

For taking up of the good container 5 or row of containers 62 by the accommodating conveying arrangement 18, which is adjustable in the direction of the lifting action conveying arrangement 7—in accordance with arrow 65—, the gripper head 57 is moved to the jib 50 in the end position away from the lifting action conveying arrangement 7 and the gripper head 57 and/or lever arm 58, provided on the one hand with lifting hooks 64 and on the other with the vacuum suction device 60, is moved by means of the adjusting means 60 to the engaging position for the lifting hook 64.

In the shown example of embodiment the goods container 5 or row of containers 62 is, through the arrangement of several adjacent lifting hooks 64, provided for depalletising, slightly tilted by the raising of the jib 50—in accordance with arrow 66—whereby a wedge-shaped free space is created between the layers 3 which allows the introduction of the wedge-shaped conveying module 34 between the layers 3 during the movement of the accommodating conveying arrangement 18, whereby the lifting hook 64 is disengaged through the movement of the lever arm 58.

Subsequently, the goods container 5 or row of containers 62 is removed by the conveying means 20, the upper belt of which runs in the removal direction—in accordance with arrow 17, and opposite to the adjusting direction—in accordance with arrow 65.

This procedure can of course take place in the described manner for each further row of containers 62 to be taken up. FIG. 6 shows the abutment arrangement 39 with the abutment means 41 for securing the goods 4 and/or goods containers 5 during the depalletising procedure as already described in the preceding figures. The figure also shows the retention means 44 attached below the accommodating conveying arrangement 18, in the shown example of embodiment, pivotably on the ceiling 16.

It can also been seen from FIG. 6 that through the independent adjustment of the accommodating conveying arrangement 18 and the transfer conveying arrangement 19 during a depalletising procedure and transfer of the goods container 5 from the accommodating conveying arrangement 18, good containers 5 already located on the transfer conveying arrangement 19 are removed after adjustment of the transfer conveying arrangement 19 in the direction of the removal arrangement 29—in accordance with arrow 67. In this way a higher degree of flexibility of the conveying apparatus 1 in accordance with the invention is achieved through a reduction in idle times, which in turn increases the goods turnover and cost-efficiency of such installations.

Another embodiment of the conveying apparatus 1 in accordance with the invention is shown in FIG. 7. Here the accommodating conveying arrangement 18 is arranged on a loading carrying means 13 of a shelf operating device 69 provided with telescopic extension 68.

For example, the shelf operating device 69 is envisaged preferably for automated goods turnover in a shelf corridor 70 between rows of shelves 71, 72 of a shelf store 73.

In the shown example the shelf store 72 is designed for the storage of goods 4 or goods containers 5 stacked on goods supports 2.

By way of the telescopic extension 68 the accommodating conveying arrangement 18 can be fully retracted for depalletising and/or also palletising in the rows of shelves 71, 72 facing each other, in order, for example, to take up rows of goods containers 62 or entire layers, and by means of the moveable shelf operating device 69 to transfer them to different storage locations or remove them from the shelf store 72, or to remove them from a goods support 2 and thereby fill a goods support 2 for storage or for goods removal.

Thus, within and outside the shelf store 73, for example at a time in which no continuous goods removal is taking place, order-related goods removal can be commissioned and provided.

As can also be seen from FIG. 7, on the load carrying means 13, a guide arrangement 75 is provided, formed of telescopic side shields 76 arranged on both sides of the accommodating conveying arrangement 18 which can preferably be synchronously adjusted in order to be introduced into the storage space 74 for removing goods 4. At opposite ends of the side shields 76 end flaps 77 are arranged by means of adjusting means in a pivoting manner in the direction of the load carrying surface 78 of the load carrying means, which support the goods 4 and/or goods containers 5 with holding rails extending between the opposing end flaps 77 and thereby assure transfer onto the removal arrangement 18. This embodiment of the guide arrangement 75 allows a low structural height and does not require any additional free spaces in terms of height in the storage location in the shelf store 73.

The side shields 76 are preferably adjustable in a perpendicular direction to the load carrying surface 78, in accordance with the double arrow, and thereby adjustable at a distance to the load carrying surface 78 and can be adjusted to different heights of the layers 5, as a result of which the free clearance height in the shelf store 73 can be kept low.

To service the rows of shelves 71, 72 on both sides of the shelf operating device 69, the drive of the actuator 20 of the accommodating conveying arrangement 18 is of course designed for reversible operation and in opposite end area of the conveyor belt the wedge-shaped conveying modules 34, and possibly also the conveyor rollers 36 are envisaged in order to allow the introduction of the accommodating conveying arrangement 18 into a separating level of the stack.

FIG. 7 also shows controlling and monitoring device 79, with a computer 80 and data memory 81 for controlling and/or monitoring the storage and removal procedures with the conveying apparatus 1, which as an external device communicates with a central computer 82.

The exchange of data between the central computer 82 and the external control and monitoring device 78 takes place, for example, via cables, but transmission of control and regulation signals via a wireless transmission system is also possible. Also connected to the control and monitoring system 79 are other recording means 83, e.g. code readers, proximity sensors, position sensors etc.

Via regulation and monitoring means 84 provided in the computer 80 of the control and monitoring device 79, operation of the drives of the lifting action conveying arrangement 7 and/or shelf operating device 69 and/or the accommodating conveying arrangement 18 and/or the transfer conveying arrangement 19 and/or the abutment arrangement 39 and/or the guide arrangement 75 and/or the removal and/or lifting arrangement 45 can be carried out and monitored in terms of their effect and relationship with regard to each other in accordance with a regulation matrix stored in the data memory 81 depending on at least one specified parameter or a physical parameter of the conveyed items, more particularly the goods 4 and/or goods container 5, e.g. weight, dimensions, layer number, layer height, support area, that has been recorded by a recording means 83, e.g. data reader, scanner etc.

This is made possible in that via the recording means 83, goods codes provided on the goods support 2 and/or the goods 4 and/or the goods container 5 are read, and from this and the data stored in the data matrix of the data memory 81 control parameters are generated, and from computer-administered data and store occupancy data stored in the data matrix and from recorded order-related commission data the control parameters are generated for order-related good separation, and in that from computer-administered store-occupancy data for the shelf store 73 stored in the data matrix and recorded, order-related commission data the control parameters for order-related repalletising of the container are generated.

FIG. 8 shows a further embodiment of the abutment arrangement 39 with the adjustable abutment means 41. Adjustability of the abutment means 41 limiting the accommodating space 40 allows the accommodation of a goods support, preferably an EU pallet, box etc, in a longitudinal or transverse direction.

The abutment means 41 are borne on the carrier frame 39 by rolling apparatuses 85 and are adjustable by means of actuators 86 between the inner position and outer position.

The carrier frame 38 is guided adjustably on the post 9 by means of the lifting drive 37 and is adjustable by means of drives 90, e.g. pressure cylinders, spindle drives, cable drives etc, on guide means 87 via pivoting arrangements 88 about a pivoting axle 89 running parallel to the support surface 8 and perpendicularly to the removal direction—in accordance with arrow 17—from the position shown in continuous lines to a position shown in broken lines.

This allows, in the case of a layer of goods or goods containers held between the lateral abutment means 41, through moving the carrier frame into the angular position, the formation of a wedge-shaped intermediate space between layer of goods to be lifted and the remaining layer, so that the—not shown—accommodating conveying arrangement can be introduced between the layers without much friction resistance.

FIG. 9 show another embodiment of the removal and lifting arrangement 45 with the jib 50 and gripping arrangement 54 adjustable thereon—in accordance with double arrow 93—by means of travelling slide 81 and for example a cable drive 92.

The jib 50 is vertically adjustable in a vertical guide rail 94 and rolling apparatus 95, and for example a further cable drive 96, in order, as shown, to remove separating layer 6 from the stacked goods containers 5.

The jib 50 is also pivotable, in a plane parallel to the support surface 8, on the rolling apparatus 95 via a pivoting bearing 98 forming the vertical pivoting axle 99 and a pivoting drive 100. In this way a depositing position of the gripping arrangement 54 can be achieved through turning about approximately 90° from the shown layer, whereby the separating layer 6 can be deposited next to the lifting action conveying arrangement 7.

All details of value ranges in the present description should be taken to mean that they include any and all partial ranges, e.g. the indication 1 to 10 is taken to mean that all partial ranges starting from the lower limit of 1 to the upper limit of 10 are included, i.e. all partial ranges beginning with a lower limit of 1 or more and ending with an upper limit of 10 or less, e.g. 1 to 1.7, or 3.2 to 8.1 or 5.5 to 10.

The examples of embodiment show possible variants of the conveying apparatus, whereby it should be mentioned at this point that the invention is not limited to the specially illustrated embodiment variants, but that various combinations of the individual embodiment variants are possible and on the basis of the technical teaching of the present invention this possibility of variation forms part of the skill of a specialist in this technical field. Therefore, all conceivable embodiment variants possible through the combination of individual details of the shown and described embodiment variants are included in the scope of protection.

For the sake of good order it is finally pointed out that for a better understanding of the structure of the conveying apparatus, it and/or its components have been shown not to scale and/or enlarged and/or reduced. The underlying aim of the separate inventive solutions can be gleaned from the description.

Above all the individual embodiment shown in FIGS. 1, 2; 3, 4; 5; 6; 7; 8; 9 can form the subject matter of separate inventive solutions. The relevant tasks and solutions in accordance with the invention are set out in the detailed descriptions of these figures.

List of references

| | |
|---|---|
| 1 | Conveying apparatus |
| 2 | Goods support |
| 3 | Layer |
| 4 | Goods |
| 5 | Goods container |
| 6 | Separating layer |
| 7 | Lifting action conveying arrangement |
| 8 | Support surface |
| 9 | Post |
| 10 | Guide arrangement |
| 11 | Lifting drive |
| 12 | Tension drive |
| 13 | Load carrying means |
| 14 | Double arrow |
| 15 | Roller or tension means conveyor |
| 16 | Ceiling |
| 17 | Arrow |
| 18 | Accommodating conveying |
| | arrangement |
| 19 | Transfer conveying arrangement |
| 20 | Conveying means |
| 21 | Conveying plane |
| 22 | Guide path |
| 23 | Adjusting drive |
| 24 | Adjusting drive |
| 25 | Arrow |
| 26 | Arrow |
| 27 | Space |
| 28 | Length |
| 29 | Removal device |
| 30 | Conveyor belt |
| 31 | End area |
| 32 | Carrier frame |
| 33 | Coupling means |
| 34 | Conveying module |
| 35 | Run-on plane |
| 36 | Conveying roller |
| 37 | Lifting drive |
| 38 | Carrier frame |
| 39 | Abutment arrangement |
| 40 | Accommodating space |
| 41 | Abutment means |
| 42 | Actuating means |
| 43 | Double arrow |
| 44 | Retention means |
| 45 | Removal and/or lifting arrangement |
| 46 | Guiding arrangement |
| 47 | Travelling slide |
| 48 | Drive |
| 49 | Guiding arrangement |
| 50 | Jib |
| 51 | Lifting drive |
| 52 | Double arrow |
| 53 | Double arrow |
| 54 | Gripper device |
| 55 | Pivoting bearing |
| 56 | Pivoting axle |
| 57 | Gripper head |
| 58 | Lever arm |
| 59 | Gripping means |
| 60 | Adjusting means |
| 61 | Vacuum suction device |
| 62 | Row of containers |
| 63 | Edge |
| 64 | Lifting hook |
| 65 | Arrow |
| 66 | Arrow |
| 67 | Arrow |
| 68 | Telescopic extension |
| 69 | Shelf operating device |
| 70 | Shelf corridor |
| 71 | Shelf row |
| 72 | Shelf row |
| 73 | Shelf store |
| 74 | Storage space |
| 75 | Control device |
| 76 | Side plate |
| 77 | End flap |
| 78 | Load bearing surface |
| 79 | Steering and control system |
| 80 | Computer |
| 81 | Data memory |
| 82 | Central computer |
| 83 | Recording means |
| 84 | Control means |
| 85 | Rolling apparatus |
| 86 | Actuator |
| 87 | Guiding means |
| 88 | Pivoting arrangement |
| 89 | Pivoting axle |
| 90 | Drive |
| 91 | Slide |
| 92 | Cable drive |
| 93 | Double arrow |
| 94 | Guide rail |
| 95 | Rolling apparatus |
| 96 | Cable drive |
| 97 | Double arrow |
| 98 | Pivoting bearing |
| 99 | Pivoting axle |
| 100 | Pivoting drive |

1. An apparatus for depalletising and removing, or advancing, goods, or goods containers which are stacked in a number of layers on a goods support, comprising:
a lifting action conveying arrangement with load carrying means for the goods support,
a conveying apparatus extending in a conveying plane perpendicular to a lifting direction, adjustable in the direction of removal of the goods relative to the load carrying means and having an inclined run-on plane facing the conveying plane,
and a removal and/or lifting device for separating layers arranged between the layers or goods or goods containers,
the conveying apparatus is formed by an accommodating conveying arrangement forming a run-on level, adjustable reversibly in the conveying direction via an adjusting drive in a guide path, and at least one transfer conveying arrangement arranged downstream in the removal direction and independently adjustable relative to the accommodating conveying arrangement via an adjusting drive in the guide path, and
the removal and/or lifting device has a gripping arrangement facing the conveying plane and arranged on a post of the lifting action conveying arrangement adjustably in a direction perpendicular to the conveying plane, the gripping arrangement being adjustable in at least one further spatial direction.

2. The apparatus in accordance with claim 1, wherein the removal and/or lifting arrangement via a drive is provided with a travelling slide along a guiding arrangement of the post in a direction perpendicular to the conveying plane.

3. The apparatus in accordance with claim 1, wherein the gripping arrangement is arranged reversibly adjustable in the removal direction on a jib arranged on the travelling slide.

4. The apparatus in accordance with claim 3, wherein the jib with the gripping arrangement is adjustably guided in a guiding arrangement running transverse to the removal direction and parallel to the conveying plane.

5. The apparatus in accordance with claim 3, wherein the jib with the gripping arrangement (54) is borne in a pivoting bearing and can be pivoted by means of a pivoting drive about an pivoting axle perpendicular to a load bearing surface of the load carrying means.

6. The apparatus in accordance with claim 1, wherein an adjusting path of the gripping arrangement in the removal direction approximately corresponds to a maximum length of the goods support and/or depth of the load carrying means.

7. The apparatus in accordance with claim 1, wherein an adjustment of the gripping arrangement in the direction transverse to the removal direction is greater than a conveying width of the accommodating conveying arrangement.

8. The apparatus in accordance with claim 1, wherein the gripping arrangement is formed by a lifting hook.

9. The apparatus in accordance with claim 1, wherein the gripping arrangement is formed by a vacuum suction device.

10. The apparatus in accordance with claim 1, wherein the adjusting drive is drive-connected with a carrier frame of the accommodating conveying arrangement by means of a elastic coupling element.

11. The apparatus in accordance with claim 1, wherein the adjusting drive of the accommodating conveying arrangement is designed for a force-adjustable advancing movement of the accommodating conveying arrangement.

12. The apparatus in accordance with claim 1, wherein on the load carrying means or on the post of the lifting action conveying arrangement, adjustable in the direction of lifting relative to the load carrying means there is, bounded on three sides and open towards the accommodating conveying arrangement an accommodating space for an abutment arrangement surrounding at least one layer of goods formed of abutment means independently adjustable relative to each other between an inner position and an outer position.

13. The apparatus in accordance with claim 12, wherein the abutment arrangement is arranged on a carrier frame which is adjustably guided on the post via a lifting drive.

14. The apparatus in accordance with claim 12, wherein an area below the conveying plane retention means extending over the conveying width, independent of the load carrying means, are arranged adjustable in the direction of the accommodating space.

15. The apparatus in accordance with claims 12, wherein the abutment means of the abutment arrangement have several tensioning means arranged between the inner and outer position and adjustable independently of each other.

16. The apparatus in accordance with claim 15, wherein the tensioning means arranged in the opposing abutment means are practically synchronously adjustable.

17. The apparatus in accordance with claim 12, wherein the abutment arrangement is borne adjustably on the post of the load carrying means in a direction running perpendicular to a load carrying surface of the load carrying means.

18. The apparatus in accordance with claim 12, wherein the abutment arrangement is pivotable between a plane running parallel and a plane running at an angle to the loading bearing surface.

19. The apparatus in accordance with claim 12, wherein the abutment arrangement with the abutment means is pivotably borne on the carrier frame about a pivoting axle running parallel to the conveying plane.

20. The apparatus in accordance with claim 14, wherein the retention means are formed by a stop shield extending over the conveying width.

21. The apparatus in accordance with claim 15, wherein the drives of the abutment means and/or tensioning means and/or retention means are formed, by an actuator operated with a pressurised medium.

22. The apparatus in accordance with claim 1, wherein, an end section of the accommodating conveying arrangement at least one conveying module forming the run-on plane is detachably arranged via coupling means.

23. The apparatus in accordance with claim 22, wherein the coupling means are essentially elastic in the removal direction of the goods and/or goods containers.

24. The apparatus in accordance with claim 22, wherein the conveying module is borne in a pivoting manner on the accommodating conveying arrangement about a pivoting axle running parallel to the conveying plane and perpendicular to the removal direction for adjusting the inclination of the run-on plane.

25. The apparatus in accordance with claim 22, wherein the conveying module is arranged on the carrier frame of the accommodating conveying arrangement in an adjustable, spring-loaded manner essentially in direction of removal of the goods and/or goods containers.

26. The apparatus in accordance with claim 22, wherein the conveying width one or more of the conveyor modules are arranged interchangeably on the carrier frame.

27. The apparatus in accordance with claim 22, wherein the conveying module is formed by a belt or strap conveyor.

28. The apparatus in accordance with claim 22, wherein a driving conveyor roller is arranged before the conveyor module.

29. The apparatus in accordance with claim 28, wherein the conveyor roller is adjustably borne, in a spring-loaded manner, on the carrier frame essentially in the removal direction of the goods and/or goods containers.

30. The apparatus in accordance with claim 28, wherein the conveyer roller is provided with a surface exhibiting a high coefficient of friction.

31. The apparatus in accordance with claim 22, wherein the conveyor module is drive-connected with a drive arrangement of the accommodating conveying arrangement.

32. The apparatus in accordance with claim 22, wherein the conveying module is provided with a drive independent of the accommodating conveying arrangement.

33. The apparatus in accordance with claim 22, wherein the accommodating conveying arrangement with the conveying module is arranged on the load carrying means of the lifting action conveying arrangement.

34. The apparatus in accordance with claim 1, wherein the lifting action conveying arrangement is formed by a shelf operating device.

35. The apparatus in accordance with claim 22, wherein the accommodating conveying arrangement with the conveying module is arranged on a telescopic extension arranged on the load carrying means of the shelf operating device.

36. The apparatus in accordance with claim 1, wherein telescopic side shields are arranged on both sides of the accommodating conveying arrangement on load carrying means above the conveying plane extending in the longitudinal direction of the load carrying means, adjustable in the perpendicular direction to the load carrying surface of the load carrying means.

37. The apparatus in accordance with claim 36, wherein end flaps are arranged on the opposite ends of the side shields pivotable in the direction of the load carrying surface of the load carrying means.

38. A method of operating an apparatus for depalletising and removing, or advancing, goods, or goods containers which are stacked in a number of layers on a goods support, with a lifting action conveying arrangement with load carrying means for the goods support and with a conveying apparatus extending in a conveying plane perpendicular to a lifting direction, adjustable in the direction of removal of the goods relative to the load carrying means and having an inclined run-on plane facing the conveying plane, and with a removal and/or lifting device for separating layers arranged between the layers or goods or goods containers, the method comprising:
using regulation and monitoring means provided in the computer of the control and monitoring device, to carry out operation of the adjusting drives and drives of the lifting action conveying arrangement (7) and/or the accommodating conveying arrangement (18) and/or the transfer conveying arrangement (19) and/or the removal and/or lifting arrangement (45) in terms of their effect and relationship with regard to each other in accordance with a regulation matrix stored in a memory of the regulation and control means depending on at least one specified parameter or a physical parameter of the conveyed items, that has been recorded by a recording means.

39. The method in accordance with claim 38, wherein goods codes on a goods support and/or a goods container are read by the recording means and from the data contained in the good code and data stored in the data matrix the control parameters are generated.

40. The method in accordance with claim 38, wherein, from computer-administered and store occupancy data stored in the data matrix and recorded order-related commission data, control parameters for order-related goods separation are generated.

41. The method in accordance with claim 38, wherein, from computer-administered and store occupancy data of a shelf store stored in data matrix and order-related commission data, control parameters for order-related repalletising of the goods containers are generated.
